(19) United States
(12) Patent Application Publication
(10) Pub. No.: US 2007/0036227 A1
(43) Pub. Date: Feb. 15, 2007

(54) Video encoding system and method for providing content adaptive rate control

(76) Inventors: Faisal Ishtiaq, Chicago, IL (US); Bhavan R. Gandhi, Vernon Hills, IL (US); Zhu Li, Palatine, IL (US)

Correspondence Address: MOTOROLA, INC., 1303 EAST ALGONQUIN ROAD, IL01/3RD, SCHAUMBURG, IL, 60196, US

(21) Appl. No.: 11/204,212

(22) Filed: Aug. 15, 2005

(51) Int. Cl. H04N 7/12

(52) U.S. Cl. 375/240.26

(57) ABSTRACT

A video encoding system (200) provides content adaptive rate control that includes a visual analyzer (208) utilizing at least one visual analysis tool for processing a video frame to provide visual information describing the video frame. An encoder (204) generates encoding status information relating to the video frame being processed. A rate controller (206) is responsive to the encoding status information generated by the encoder (204) and the visual information generated by the visual analyzer (208) to generate a rate control adjustment signal. The encoder (204) is responsive to the rate control adjustment signal for encoding the video frame.

### FIELD OF THE INVENTION

This invention relates to the field of video encoding, and in particular to using visual analysis tools and their application to the problem of rate control.

### BACKGROUND

In digital video applications the overriding factor in the visual quality of the encoded video is the number of bits per second that can be transmitted over a common channel, also known as the bit-rate. Low bit-rates allow for only lower quality video, while the higher bit-rates allow for better spatial and temporal quality. Generally the number of bits generated by an encoder is inherently variable in nature and is very much content dependent. Motion, dynamic texture, occlusions, and lighting changes are among some of the things that alter the pixel statistics from one frame to the next. However, channel requirements and/or storage requirements govern the bit-rate regardless of content. In order to regulate the number of compressed bits generated for such varying pixel data, encoders were used employing rate control methods.

The rate control methods previously used matched the bit-rate/storage requirements by trading off spatial and temporal quality in the compressed bitstream. These rate control methods regulated the volume of compressed data by adjusting the appropriate encoding controls. Intelligent rate controls adeptly allocated bits amongst the entire video while striving to achieve the best possible tradeoff between spatial and temporal quality. The rate controls were an important part of an encoding system and were key differentiators between different video encoders.

Uncompressed, or raw, digital video required tremendous amounts of bandwidth to transmit and equally large amounts of storage space to archive. Video compression standards such as MPEG-1, MPEG-2, MPEG-4, H.263 and H.264 all take advantage of the naturally existing spatio-temporal redundancies and allow for distortions in order to achieve significant bandwidth reductions. The higher the compression rate, the more distortions the encoders yielded. However, not all encoders produced the same distortions. The type and severity of distortions vary from one encoder to another and were a function of the individual encoding techniques such as motion estimation, mode selection, and rate control. Among these encoder techniques, rate control had the most impact on the overall encoded video quality.

A typical video encoding system 100, such as used in the prior art, is shown in FIG. 1. Input video frames were provided to an encoder 104 that compressed the video into an output video bitstream. The encoder 104 could compress the incoming video using any encoding methodology. This included any one of the International compression standards belonging to the hybrid motion-compensated DCT (MC-DCT) family of codecs - MPEG-1, MPEG-2, MPEG-4, H.261, H.263, and H.264.

In order to achieve a regulated output bit-rate or frame rate, the encoder 104 relied on a rate controller 106. The rate controller 106 operated by using encoding status data provided by the encoder 104 and outputted rate control adjustment data to the encoder 104. The rate control adjustment data contained parameters that affected how the current or future frames were encoded. The rate control adjustment data included information that could be provided at the beginning of a frame and continuously updated throughout the frame when the encoder 104 allowed for update information to be utilized. The information that was conveyed in the rate control adjustment data was a function of the specific encoding technique.

In the MC-DCT family of codecs, the rate controller 106 typically used frame dropping and a quantization step size, Qp, to regulate the bit-rate of the output video bitstream. Frame dropping told the encoder 104 to not code the current frame in the video frames being inputted. This reduced the number of frames in the resulting video at the expense of temporal fidelity. Qp controlled the fidelity with which a frame was coded. A larger Qp encoded a frame with less granularity resulting in fewer output bits with more distortions while a smaller Qp encoded a frame with more bits and better quality. Quantization is a lossy process that introduced distortions by reducing the fidelity of the coded data into a number of finite quantization bins. In cases where allowed, Qp could be adjusted multiple times within a frame for better control of the number of bits generated. Thus, the rate controller 106 had to be able to balance both temporal (via frame drops) and spatial quality (via the Qp) such that a fixed bit-rate budget was met.

The majority of rate control algorithms today do not give preferential treatment to the contents of the video. These rate control algorithms typically operate using only statistics, such as the number of bits generated, the average Qp from the previous frame, and the number of frames dropped to derive information for rate control adjustment. This type of rate controller 106 was described in a Sep. 1997 publication entitled “Video Codec Test Model, Near Term, Version 8 (TMN8), Test Model 8 (TM8)”. As such, the decision mechanism was agnostic to the contents of the video input. The contents of the video input did alter the encoded statistics, but the rate controller 106 did not have any more knowledge beyond this.

A rate control method that incorporated the visual properties (significance) of the video frame information provided better tradeoffs of visual quality while maintaining the desired bit-rate. As presented in an Oct. 1998 article by S. Daly, K. Matthews and J. Ribas-Corbera entitled “Face Based Visually Optimized Image Sequence Coding”, an encoding technique that used the human visual system's properties and a face detection method to allocate more bits to the facial areas is outlined. The investigators allowed for better quantizer control in the area of interest in the frame to produce video adapted to the face. This was an adaptive technique that is limited to video with facial objects. Furthermore, this technique did not take into account other aspects of the rate control such as frame dropping and I/P frame mode decisions. Another work presented in a May 2001 article by Wallace K-H Ho and Daniel PK Lun entitled “Content-based Scalable H.263 Video Coding for Road Traffic Monitoring Based on Regularity of Video Content”, focused on content adaptive scalable H.263 coding for use in traffic monitoring. In this method the investigators extracted and classified moving objects in the scene to enable the rate control to operate nearly 20% more efficiently. However, this technique involved segmenting vehicles and was tailored specifically to traffic scenes and could not be applied to other types of video. Another technique using video analysis to allow better encoding was also investigated by Liang-Jin Lin and A. Ortega in an Oct. 1997 article entitled “Perceptually Based Video Rate Control Using Pre-filtering and Predicted Rate-distortion Characteristics”. In this technique pre-filtering of the video to classify areas within a frame to assist in a rate-distortion-based rate control was used. This resulted in better video with fewer artifacts. However, this method focused heavily on blocking artifact reduction and worked within a rate-distortion-optimized framework that was not feasible for real-time and low power application scenarios. Furthermore, it did not address the issues of frame dropping or frame type selection.

Visual analysis techniques today allow detailed analysis of the properties of the video sequence data. These tools have recently become important in categorizing, indexing, and organizing the ever-increasing volumes of digital data. Built on the foundations of basic image processing techniques, these tools provide statistical parameters that describe motion, texture, lighting, and complexity of a video frame. Examples of these tools can be found in the MPEG-7 Multimedia Content Description Interface Standard described in Information Technology - Multimedia Content Description Interface Part 3. In particular, the MPEG-7 standard provide for the MPEG-7 Visual Description Tools that extract color, texture, shape, motion, localization, and face recognition features of a video segment.

The MPEG-7 visual metrics offered were the result of research in multimedia information processing and digital library spanning the past decade. A visual metric is comprised of a visual feature definition, known as D, or Descriptor in MPEG-7 and an associated metric function. MPEG-7 defines a set of visual metrics for Color, Shape, Texture and Motion, which were validated by experiments to be compatible to subjective human perception. Among these visual metrics are the Color Layout Descriptor, or CLD, described in a Jun. 2001 article by B. S. Manjunath, J. R. Ohm, V. V. Vasudevan and A. Yamada, entitled “Color and Texture Descriptors”, and the Motion Activity Descriptor, or MAD, also described in a Jun. 2001 article by Jeannin and A. Divakaran, entitled “MPEG-7 Visual Motion Descriptors”.

The Color Layout Descriptor is a color feature that describes the rough color layout of the image. The CLD is very useful in describing the difference, or distance, between two frames of a video. Applied to successive frames, the CLD metric is a good approximation of visual content changes throughout a video sequence. The CLD can be used in a variety of measurements and has been used as a one-pass frame selection mechanism for video summaries as described in published U.S. patent application Ser. No. 20040085483. The Motion Activity Descriptor captures the amount of object motion in a video frame. It is based on the variance of the magnitude of motion vectors (MV) in the frame rather than the mean of the magnitude of MVs, which can be easily distorted by global camera motion. The MAD has shown to be a good measure of motion activity in a frame.

What is needed is an encoder that uses knowledge of the contents of the video input in a rate control mechanism that can allow a rate controller to make more visually significant decisions.

What is also needed is a method of rate control that incorporates the visual properties of the video frame data to provide better visual quality in an encoded video sequence while adhering to a desired bit-rate.

What is also needed is a method of rate control that uses visual analysis tools such as those specified in MPEG-7 to assess the significance of video frames being encoded.

What is also needed is a rate controller that utilizes visual analysis tools to provide information in the form of a rate control adjustment signal to an encoder to encode video frames having fewer distortions and better compression efficiency.

### BRIEF DESCRIPTION OF THE DRAWINGS

FIG. 1 is an electrical block diagram of a prior art video encoding system.

FIG. 2 is an electrical block diagram of a video encoding system providing content adaptive rate control in accordance with the present invention.

FIG. 3 is an electrical block diagram of a visual analyzer and rate controller utilizing visual analysis tools in accordance with the present invention.

FIG. 4 is a diagram depicting frame compression efficiency using visual metrics in accordance with the present invention.

FIG. 5 is a flow chart depicting frame drop decisions and preserved frame encoding in accordance with the present invention.

FIG. 6 is a flow chart depicting quantization parameter selection in accordance with the present invention.

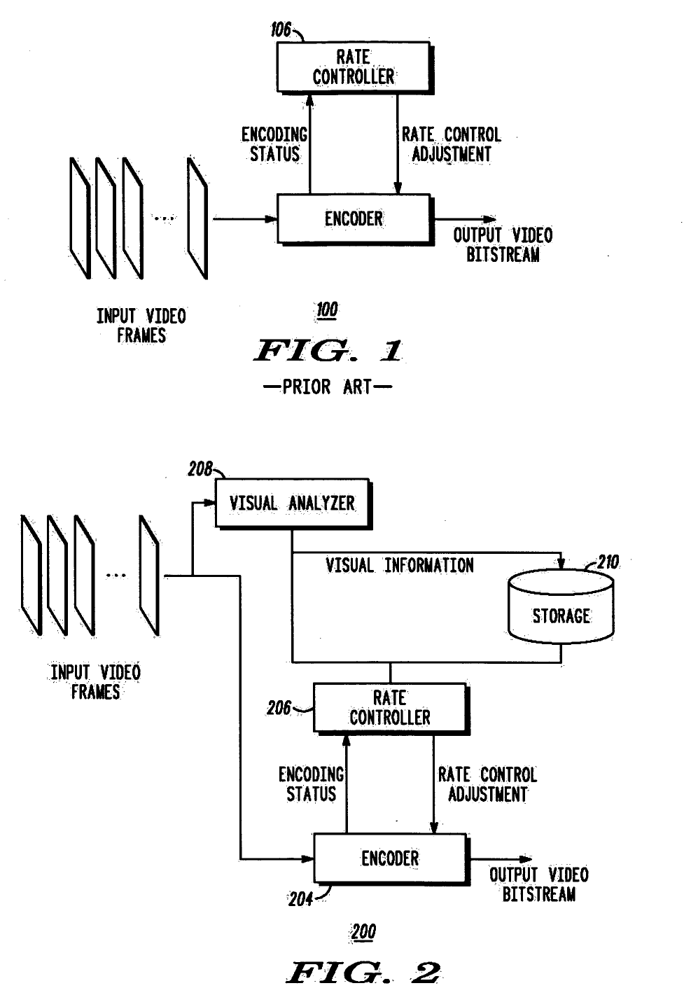

### DETAILED DESCRIPTION

While this invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described. In the description below, like reference numerals are used to describe the same, similar or corresponding parts in the several views of the drawings.

The MPEG-7 visual metrics described above have not previously been utilized in implementing content adaptive rate control. Likewise, the earlier MPEG-1, MPEG-2, MPEG-4, and H.261 visual metrics, nor more recently proposed H.263, and H.264 standard visual metrics described above have not been previously utilized in implementing content adaptive rate control.

FIG. 2 is an electrical block diagram of a video encoding system 200 providing content adaptive rate control in accordance with the present invention. Video frames are input to both a visual analyzer 208 and an encoder 204. The encoder 204 provides encoding status data to a rate controller 206 that outputs rate control adjustment data back to the encoder 204. The rate controller 206, in turn, is provided with visual information that includes a visual analysis metric derived from the video frames being input to the visual analyzer 208, as will be described below. The visual information is computed in real time or pre-computed and stored in a storage device 210 for later use. The visual information includes such information as flags and parameters that describe the contents of the video in a parameterized form as well as information about key areas or instances within the video that should be treated preferentially. The rate controller 206 uses this macroscopic video content information to make active decisions during the encoding process.

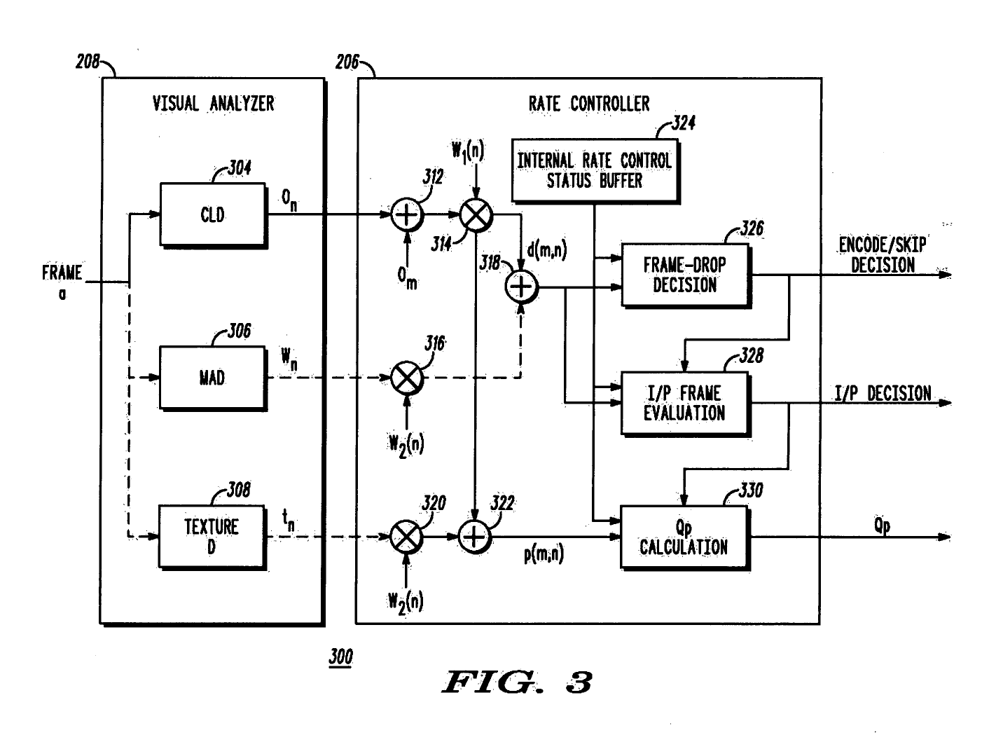

FIG. 3 is an electrical block diagram of a visual analyzer and rate controller 300 utilizing visual analysis tools in accordance with the present invention to provide content adaptive rate control. A video frame (n) is inputted to the visual analyzer 208 which can use a variety of visual analysis tools, such as, but not limited to, a Color Layout Descriptor (CLD) tool 304, a Motion Activity Descriptor (MAD) tool 306 and a Texture Descriptor (TD) tool 308. Visual analysis tools such as the Motion Activity Descriptor (MAD) tool 306 and a Texture Descriptor (TD) tool 308 are implemented as elements of the visual analyzer 208 to provide increased performance, and are therefore indicated as such by the use of dashed input and output signal lines.

The Color Layout Descriptor tool 304 determines the rough color layout of the video image in the video frame, determining the difference, or distance, between two video frames. The Color Layout Descriptor tool 304 is applied to successive video frames and generates a CLD metric Cₙ, that provides an approximation of the visual content changes throughout a video sequence. When implemented, the Motion Activity Descriptor tool 306 determines the amount of object motion in a video frame. The Motion Activity Descriptor tool 306 is also applied to successive video frames and generates a MAD metric vₙ that provides a measure of motion activity in a frame. Also when implemented, the Texture Descriptor tool 308 determines the texture of the video image in the video frame. The Texture Descriptor tool 308 is also applied to successive video frames, to generate a TD metric tₙ that provides a measure of texture within a frame.

The visual analyzer 208, in accordance with the present invention associates frame m to be the most recently encoded frame and frame n to be the current source frame. In accordance with the present invention, it is assumed that the value of m is less than n although this need not be the case. The CLD metric Cₙ for frame n is calculated in the visual analyzer 208 and supplied to the rate controller 206 to decide frame drops. When implemented, the MAD metric vₙ and the TD metric tₙ for frame n are also calculated in the visual analyzer 208 and are supplied to the rate controller 206 to decide frame coding modes (I/P/B), and the quantization step size Qp, respectively, as will be described below.

The rate controller 206 in accordance with the present invention utilizes Boolean adders and multipliers, such as adder 312, and multiplier 314, and may additionally include adders 318 and 322, and multipliers 316 and 320 as will be described in detail below. The output of the Color Layout Descriptor tool 304 couples to a first input of adder 312. The input to a second input of adder 312, and the operation thereof will be described below. The output of adder 312 couples to a first input of multiplier 314. The input to a second input of multiplier 314, and the operation thereof will be described below. When implemented, the output of the Motion Activity Descriptor tool 306 is coupled to a first input of multiplier 316. The input to a second input of multiplier 316, and the operation thereof will be described below. Also when implemented, the output of the Texture Descriptor tool 308 is coupled to a first input of multiplier 320, The input to a second input of multiplier 320, and the operation thereof will be described below.

The output of multiplier 314 is coupled to a first input of adder 318 when the Motion Activity Descriptor tool 306 is implemented, otherwise it couples directly to an input of a frame drop decision element 326. When the Motion Activity Descriptor tool 306 is implemented, the second input of adder 318 is coupled from the output of multiplier 316. The output of adder 318 is the coupled to an input of the frame-drop decision element 326 and an input of an I/P frame evaluation element 328. An internal rate control status buffer 324 provides rate control status information that is coupled to a second input of the frame-drop decision element 326 and when the Motion Activity Descriptor tool 306 is implemented to a second input of the I/P frame evaluation element 328. The frame-drop decision element 326 processes the information generated by the internal rate control status buffer 324 and the output of adder 318 to determined when a frame n will be dropped, as will be described further below, and generates encode/skip decision data at the output.

The output of the frame-drop decision element 326 also couples to an input of the I/P frame evaluation element 328 when the Motion Activity Descriptor tool 306 is implemented. When the frame-drop decision element 326 determines frame n will not to be dropped the encode/skip decision data is coupled the I/P frame evaluation element 328 to enable its operation. The I/P frame evaluation element 328 determines whether frame n is to be defined as an intra frame or an inter frame, as will be described further below, and delivers I/P decision data at the output.

When the Texture Descriptor tool 308 is implemented, the output of multiplier 320 is coupled to an input of adder 322. A second input of adder 322 is coupled to a second output of multiplier 314. The output of adder 322, which will be described in detail below, is coupled to an input of Qp calculation element 330. A second input of Qp calculation element 330 is also coupled to the output of the internal rate control status buffer 324. The Qp calculation element 330 processes the inputs, as will be described below, and outputs a Qp signal defining the spatial quality of the video frame being processed.

In the present invention the rate controller 206 determines frame drops using frame-drop decision element 326. The rate controller 206 further determines frame coding modes using I/P frame evaluation element 328 by computing a distance metric d(m, n) between frames m, and n. This distance metric is defined as
d(m,n)=w₁(n)·(cₙ−cₘ)
where cₘ is the CLD of frame m and w₁(n) is a weighting factor for frame n. When the Motion Activity Descriptor tool 306 is implemented, as shown in FIG. 3, dₖ(n) utilizes both the CLD metric and the MAD metric to compute the distance as
d(m,n)=w₁(n)·(cₙ−cₘ)+w₂(n)·mₙ
where mₙ is the MAD metric and w₂ (n) is a weighting factor for frame n. This combination of visual analysis metrics links the rate control operation more tightly to the video and can allow better responsiveness.

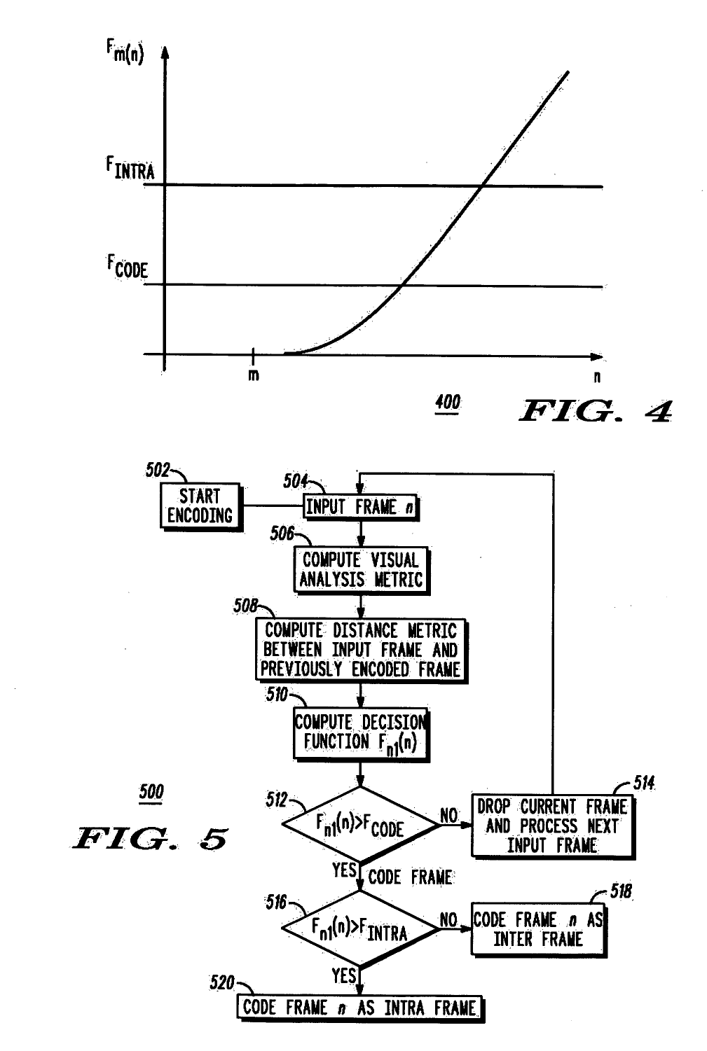

Frame drop decisions generated in the frame-drop decision element 326 are made using the distance d(m, n) in conjunction with internal rate control status information such as provided by the internal rate control status buffer 324 contents, and the time elapsed since the last encoded frame m. In the present invention a frame drop decision function incorporating the various parameters is computed as

$${F}_{m} ( n ) = d ( m , n ) + η ( n ) \cdot s ( m , n ) - γ ( n ) \cdot \frac{1}{{f}_{m} ( n )}$$

where ƒₘ(n) is the non-zero probability of encoding n given m has been encoded, s(m, n) is the temporal distance between the two frames, and η(n) and γ(n) are weighting factors for the current frame. An exemplary frame drop decision mechanism combining the frame drop decision and I/P/B frame decision is presented graphically in FIG. 4.

It will be appreciated from the description provided above, the video encoding system 200 providing content adaptive rate control described in FIG. 2 can be implemented in a variety of ways. The video encoding system 200 can be implemented on a mainframe computer, a workstation, a server, a personal computer (PC), a laptop computer, or other similar computing device. In such instance, the visual analyzer 208, the rate controller 206, and the encoder 204 are implemented as software routines processing the video frames being inputted, and after processing outputting encoded compressed video frames. The storage device 210 can be implemented as a hard disk drive having a storage capacity sufficient to handle the video information being processed, or and other writeable and readable data storage medium having a capacity sufficient to handle the video information being processed.

It will be appreciated from the description provided above, that the encoding system 200 providing content adaptive rate control includes the visual analyzer 208 and the rate controller 206 described in FIG. 3, and can also be implemented as a combination of hardware and firmware elements. Examples of such implementations include, but are not limited to, field programmable gates arrays (FPGA's), application specific integrated circuits (ASIC's), and micro-controllers and microcomputers. The firmware can be implemented using, read only memories (ROMs), programmable read only memories (PROMs), electrically erasable read only memories (EEPROMs), and on-chip memories such as in embedded micro-controllers and microcomputers.

Other memory devices can be utilized as well.

FIG. 4 shows Fₘ(n) as a function of the current frame n. Also shown are two thresholds, F_{CODE} and F_{INTRA} that represent a function of the internal rate control status buffer 324 fullness, and total number of bits that are generated. In an actual implementation the frame drop decision function Fₘ(n) will be analytically obtained after frame m has been encoded.

The decision mechanism presented above uses the frame drop decision function Fₘ(n) to decide both the frame drop and whether to encode the frame as an INTRA (I) or an INTER (P/B) frame. In the present invention, the rate control algorithm compares the frame drop decision function Fₘ(n) to the F_{CODE} threshold. When Fₘ(n) is less than F_{CODE}, frame n is dropped and not coded. When Fₘ(n) is larger than F_{CODE} but less than F_{INTRA}, the frame coding parameter, frame n is selected for encoding as a P or B frame. If Fₘ(n) exceeds both F_{CODE} and F_{INTRA}, frame n is encoded as an INTRA frame. Additionally, Fₘ(n) can be used by the rate control to request more INTRA macroblocks in an INTER frame as Fₘ(n) approaches F_{INTRA}. The frame drop and mode mechanism is used after the first frame has been encoded using predefined parameters.

The frame drop mechanism is important in regulating the encoded bit-rate. However, without associated visual information about the source video, it can cause important, or key, frames to be dropped. Using visual information data derived from the Color Location Descriptor tool 304 and Motion Activity Descriptor tool 306, the rate controller 206 can better estimate those frames to encode that may otherwise have been dropped. In cases where visual information for future frames is known the rate controller 206 can tailor its operation based upon knowledge that certain frames in the future will have to be encoded while others can be sacrificed.

The quantization parameter, Qp, is generated using the internal rate control status information located in the internal rate control status buffer 324 p(m, n) augmented with the visual information quantization metric p(m, n). In this embodiment Qp is a function of the CLD metric p(m, n) and defined as
p(m, n)=w₁(n)·(cₙ−cₘ)

Alternative embodiments can define the visual information quantization metric as a function of both the CLD metric p(m, n) and the TD metric tₙ as
p(m, n)=w₁(n)·(cₙ−cₘ)+w₃(n)·tₙ
where w₃(n) is a weighting factor or use the CLD metric cₙ, MAD metric vₙ, and TD metric tₙ, as
p(m,n)=w₁(n)·(cₙ−cₘ)+w₂(n)(mₙ−mₘ)+w₃(n)·tₜ.

While all rate control techniques have specific Qp calculation algorithms, p(m,n) can be used to either offset the calculated Qp or as an integral part of the calculation. Let bₘ be the number of bits generated by encoding frame m using an average Qp, q̅ₘ, and bdₙ be the desired number of bits to be spent on the current frame n. In the present invention, the new Qp for frame n, qₙ, is then calculated as

$${q}_{n} = {\overline{q}}_{m} \cdot ( 1 + \frac{{b}_{m} - {bd}_{n}}{α \cdot {bd}_{n}} + β \cdot p ( m , n ) )$$

where α and β are weighting coefficients that are predefined or dynamically obtained. qₙ is the initial quantization step size for the current frame. As statistics are obtained as the frame is being coded, the quantization step size can be adjusted multiple times throughout the frame to achieve the target number of bits. qₙ is set to a desired value for encoding of the first frame of the video sequence where q̅ₘ and bₘ are unavailable.

Utilizing the CLD metric and TD metric, the rate controller 206 is able to better derive the Qp value. A high texture region will require more bits during the encoding. To ensure that the bit-rate is evenly regulated, the Qp calculation element 330 in the rate controller 206 can respond with a higher Qp to balance the source video's high complexity characteristic. It should also ensure that too much detail is not lost because of the high Qp that results in blocking artifacts. In low texture regions, the Qp calculation element 330 in the rate controller 206 can reduce the Qp to adapt to the easy nature of the frame. This will also reduce annoying quantization artifacts that are visible in low texture regions and due to Qp variations.

FIG. 5 is a flow chart depicting frame drop decisions and preserved frame encoding in accordance with the present invention. The video encoding system 200 providing content adaptive rate control.

In accordance with the present invention begins the encoding process at step 502. A sequence of video frames is sequentially inputted beginning with frame n at step 504. One or more visual analysis metrics are computed as described above for the video frame inputted at step 508. A distance metric is computed between the input frame n and a previously encoded frame m, at step 508. A decision function Fₘ(n)is computed at step 510. The computed decision function Fₘ(n) is compared to a first threshold, F_{CODE}, at step 512, which is used to determine when a video frame should be dropped. When F_{CODE} is less than Fₘ(n), at step 512, the frame-drop decision element 326 generates an encode/skip decision signal to drop video frame n, and the encoder 204 drops video frame n, at step 514. When Fₘ(n) is greater than F_{CODE} at step 512, the frame-drop decision element 326 generates an encode/skip decision signal to code video frame n

Fₘ(n) is compared to a second threshold, F_{INTRA}, the frame coding parameter, at step 516, which is used to determine the type of encoding to be performed. When Fₘ(n) is less than F_{INTRA}, at step 516, the I/P frame evaluation element 328 generates an I/P decision signal to encode video frame n as an INTER frame, i.e. frame n data is encoded as processed. When Fₘ(n)is greater than F_{INTRA}, at step 516, the I/P frame evaluation element 328 generates an I/P decision signal to encode video frame n as an INTRA frame, i.e. the difference between the current frame n and the previous frame m is calculated, and the difference is encoded.

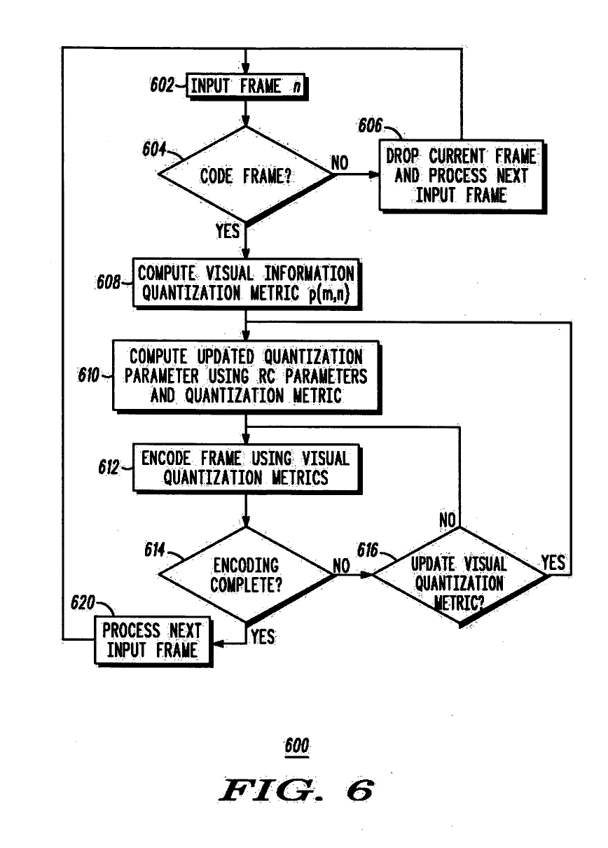

FIG. 6 is a flow chart depicting quantization parameter selection in accordance with the present invention. The video encoding system 200 providing content adaptive rate control in accordance with the present invention continues the encoding process wherein the sequence of video frames is sequentially inputted beginning with frame n at step 504. After having been processed in a manner described in the flow chart of FIG. 5, the frame-drop decision element 326 generates and encode/skip decision signal at step 604. When the frame-drop decision element 326 generates and encode/skip decision signal to drop frame n, the current frame is dropped by the encoder 204 and the next video frame is selected for processing, at step 606. When the frame-drop decision element 326 generates and encode/skip decision signal to preserve current frame, frame n is evaluated, a visual information quantization metric p(m, n) is computed for the current frame, at step 608. The visual quantization metric Qp is then computed using the visual information quantization metric p(m, n) and the parameters computed by the rate controller 206 for the current frame n, at step 610. Frame n is encoded as frame n using the visual quantization metric, Qp, at step 612. The encoder 204 then determines whether the encoding of the current video frame is complete, at step 614. When the encoding of current video frame is not complete, and the visual quantization metric has not been updated, at step 616, the process continues to step 610. When the encoding of current video frame is not complete, and the visual quantization metric does not need to be updated, at step 616, the process continues to step 612. When the encoder 204 determines the encoding of the current video frame is complete, at step 614, the decision is made to process the next video frame, at step 620 which continues with the inputting of the next frame n, at step 504.

The present invention offers a key benefit in a variety of applications. It provides a method by which video is rate controlled by analyzing the contents of the video. This method improves on the operation of existing rate controllers with the addition of visual analysis tools that provide key features about the video contents. The MPEG-7 visual descriptors are a set of tools, as described above, that can be utilized in the visual analyzer 208. The visual analyzer 208 data can also be embedded within the bitstream to avoiding regeneration at the receiving end. In pre-stored applications, and power-limited receivers such as streaming of video data to a mobile phone client, the client can utilize the pre-computed MPEG-7 data saving unnecessary computation complexity and power.

The present invention is applicable for use in a number of areas. First within the fast growing Internet applications market, the present invention offers the capability of encoding data in an adaptive manner and key in differentiating amongst other competitors. The present invention focuses on the video encoding, video database, video browsing, surveillance, public safety, storage, and video streaming applications.

The present invention is a video encoding system and method for providing content adaptive rate control that utilizes visual analysis tools in a pre-processing role to guide the encoding process. The present invention provides a decision mechanism that adjusts the rate control to adapt the encoding based upon the content as parameterized by the visual analysis tools. The visual analysis tools allow a rate control mechanism to better decide which frame to encode and which frame to drop based upon the frame's necessity in the encoded video. Furthermore, the visual analysis tools can be utilized to modify the quantization parameter (Qp) based upon the complexity of the scene and bit constraints. The present invention allows for video encoders and rate controllers that are tailored to the source content providing better coding efficiency and video quality.

While the invention has been described in conjunction with specific embodiments, it is evident that many alternatives, modifications, permutations and variations will become apparent to those of ordinary skill in the art in light of the foregoing description. Accordingly, it is intended that the present invention embraces all such alternatives, modifications and variations as fall within the scope of the appended claims.

We claim:

1. A video encoding system providing content adaptive rate control comprising:
a visual analyzer, utilizing at least one visual analysis tool, for processing a video frame to provide visual information describing the video frame;
an encoder for generating encoding status information relating to the video frame; and
a rate controller, responsive to the encoding status information, and further responsive to the visual information being generated by said visual analyzer, for generating a rate control adjustment information,
said encoder being responsive to the rate control adjustment information for encoding the video frame.

2. The video encoding system according to claim 1 wherein the video frame is processed in real time by said visual analyzer, said rate controller, and said encoder.

3. The video encoding system according to claim 1 further comprising a storage device for storing the visual information generated by said visual analyzer,
wherein the visual information being stored is used by said rate controller and said encoder for enabling the encoding of the video frame being processed.

4. The video encoding system according to claim 3, wherein the visual information includes a visual analysis metric computed by said at least one visual analysis tool for the video frame currently being processed, and wherein
said storage device stores the visual analysis metric for the video frame currently being processed and for video frames previously processed.

5. The video encoding system according to claim 4, wherein said at least one visual analysis tool is a color layout descriptor tool, and wherein
said color layout descriptor tool generates a color layout descriptor metric providing an approximation of the visual content changes throughout a video sequence.

6. The video encoding system according to claim 1, wherein said at least one visual analysis metric is used for computing a distance metric between the frame currently being processed and a frame previously processed; and wherein
said rate controller further computes a frame drop decision function using the distance metric and compares the frame drop decision function computed with a frame drop decision parameter to determine when the frame is intended to be dropped.

7. The video encoding system according to claim 6, wherein said rate controller compares the distance metric computed for the frame when the frame is not intended to be dropped with a frame coding parameter; and wherein
the rate controller generates the rate control adjustment information and in response thereto said encoder
encodes the frame as an intra-frame when the distance metric is greater than the frame coding parameter; and
further encodes the frame as an inter-frame when the distance metric is less than the frame coding parameter.

8. A video encoding system providing content adaptive rate control comprising:
a visual analyzer utilizing visual analysis tools for processing a video frame to compute visual analysis metrics describing the video frame;
a rate controller, responsive to the visual analysis metrics being computed, for computing a distance metric and a frame drop decision function, the frame drop decision function being used for determining when the video frame is intended to be dropped and when the video frame is not intended to be dropped;
said visual analyzer utilizing a visual analysis tool for processing a video frame that is not intended to be dropped to compute a visual analysis metric describing the video frame not intended to be dropped,
said rate controller further computing a visual information quantization metric using the visual analysis metric computed for the frame that is not intended to be dropped; and
an encoder for encoding the frame that is not intended to be dropped using the visual information quantization metric.

9. The video encoding system according to claim 8 wherein said visual analysis tools include at least a color location descriptor tool.

10. The video encoding system according to claim 9 wherein said visual analysis tools further include at least a motion activity descriptor tool.

11. The video encoding system according to claim 8 wherein said visual analysis tool used for process a video frame that is not intended to be dropped is a texture descriptor tool.

12. The video encoding system according to claim 8 wherein said rate controller determines when the encoding of the video frame currently being processed is complete and when the encoding of the video frame currently being processed is not complete; wherein
said rate controller updates the visual information quantization metric for the video frame currently being processed when the encoding of the frame currently being processed is not complete.

13. The video encoding system according to claim 12 wherein said rate controller: further determines when the encoding of the frame currently being processed is complete to enable the processing a next video frame of the sequence of video frames.

14. A method for video encoding using content adaptive rate control comprising:
inputting a frame from a sequence of video frames;
processing the frame using a visual analysis tool to compute a visual analysis metric describing the frame;
computing a distance metric between the frame currently being processed and a frame previously processed;
computing a frame drop decision function using the distance metric; and
comparing the frame drop decision function computed with a frame drop decision parameter to determine when the frame is intended to be dropped.

15. The method for video encoding according to claim 14, wherein said step of inputting and said step of processing are performed by a visual analyzer, said step of computing and said step of determining are performed by a rate controller and said step of encoding is performed by an encoder.

16. The method for video encoding according to claim 14, wherein the frame drop decision parameter is stored in a storage device.

17. The method for video encoding according to claim 14, wherein the visual analysis tool is a color layout descriptor tool.

18. The method for video encoding according to claim 14, further comprising:
comparing the distance metric computed for the frame when the frame is not intended to be dropped with a frame coding parameter; and
encoding the frame as an intra-frame when the distance metric is greater than the frame coding parameter; and
encoding the frame as an inter-frame when the distance metric is less than the frame coding parameter?

19. The method for video encoding according to claim 18, wherein
the frame is encoded as the intra-frame by encoding a difference between the frame currently being processed and the frame previously being processed, and
the frame is encoded as the inter-frame by encoding the frame currently being processed.

20. The method for video encoding according to claim 18, wherein the step of comparing is performed in a rate controller, and the step of encoding is performed in an encoder.

21. The method for video encoding according to claim 14, further comprising
processing the frame using a second visual analysis tool to compute a second visual analysis metric describing the frame;
computing the distance metric for the frame currently being processed using the visual analysis metric derived for the frame currently being processed and a frame previously processed and the second visual analysis metric for the frame currently being processed;
computing the frame drop decision function using the distance metric; and
comparing the frame drop decision function computed with a frame drop decision parameter to determine when the frame is intended to be dropped.

22. The method for video encoding according to claim 21, wherein the second visual analysis tool is a motion activity descriptor tool.

23. A method for video encoding using content adaptive rate control comprising:
inputting a frame from a sequence of video frames;
processing the frame using visual analysis tools compute visual analysis metrics describing the frame, the visual analysis metrics being used to compute a distance metric and a frame drop decision function, the frame drop decision function being used for determining when the frame is intended to be dropped and when the frame is not intended to be dropped;
computing a visual information quantization metric using the visual analysis metrics computed for a frame that is not intended to be dropped; and
encoding the frame using the visual quantization metrics.

24. The method for video encoding according to claim 23, further comprising:
determining when the encoding of the frame currently being processed is complete and when the encoding of the frame currently being processed is not complete; and
updating the visual information quantization metric for the frame currently being processed when the encoding of the frame currently being processed is not complete.

25. The method for video encoding according to claim 24, further comprising:
determining when the encoding of the frame currently being processed is complete;
inputting a next frame for processing.

26. The method for video encoding according to claim 20, wherein the visual analysis tools comprise at least one of a color layout description tool, a motion activity descriptor tool and a texture descriptor tool.

27. The method for video encoding according to claim 20, wherein said step of inputting and said step of processing are performed by a visual analyzer, said step of computing is performed by a rate controller and said step of encoding is performed by an encoder.
